(19) United States
(12) Patent Application Publication
(10) Pub. No.: US 2026/0178405 A1
(43) Pub. Date: Jun. 25, 2026

(54) EFFICIENT RESOURCE MANAGEMENT FOR HIGHLY CONCURRENT SCALAR-VECTOR SYSTEMS

(71) Applicant: Advanced Micro Devices, Inc., Santa Clara, CA (US)

(72) Inventor: Brian Laird Sumner, Santa Clara, CA (US)

(73) Assignee: Advanced Micro Devices, Inc., Santa Clara, CA (US)

(21) Appl. No.: 18/999,701

(22) Filed: Dec. 23, 2024

(51) Int. Cl. G06F 9/50

(52) U.S. Cl. CPC G06F 9/5044; G06F 9/5016

(57) ABSTRACT

Resources are often managed with bookkeeping information. In order for a thread to acquire a resource, the thread records that it has acquired that resource in the bookkeeping information. One technique for resource acquisition is to read the bookkeeping information to obtain a local copy, modify that local copy to indicate that one or more resources are acquired, and then perform an atomic operation to store the modified bookkeeping information to its original location. However, this technique is subject to failure and retry, which can be inefficient. To counteract this type of contention, a hardware-accelerated instruction for acquiring resources is provided. This instruction specifies the address of bookkeeping information and information indicating desired resources. When executed, the instruction atomically reads the bookkeeping information at the address to obtain a local copy, modifies that local copy to acquire the requested resources, and writes the modified local copy back to the address.

### BACKGROUND

A common operation in computing is resource acquisition. In highly parallel systems, resource acquisition can bring about very high contention, as many different threads of execution attempt to acquire the same resources at the same time. Improvements in resource acquisition are therefore important.

### BRIEF DESCRIPTION OF THE DRAWINGS

A more detailed understanding may be had from the following description, given by way of example in conjunction with the accompanying drawings wherein:

FIG. 1 is a block diagram of an example computing device in which one or more features of the disclosure can be implemented;

FIG. 2 illustrates details of the device of FIG. 1 and an accelerated processing device, according to an example;

FIG. 3 is a block diagram showing additional details of the graphics processing pipeline illustrated in FIG. 2;

FIG. 4 illustrates bookkeeping information and corresponding resources;

FIG. 5 illustrates one technique for acquiring resources;

FIG. 6 illustrates a different technique for acquiring resources, using a hardware-accelerated instruction;

FIG. 7 illustrates details of the hardware-accelerated instruction; and

FIG. 8 is a flow diagram of a method for acquiring resources.

### DETAILED DESCRIPTION

Resources, such as memory blocks, slots in a work queue, or other resources, are often managed with bookkeeping information that tracks which such resources are already allocated and which are free to be allocated. Such bookkeeping information itself can be spread across a large portion of memory.

In order for a thread of execution to acquire one of the resources, the thread of execution must record that it has acquired that resource in the bookkeeping information, at which point other threads of execution know that they cannot acquire that resource. One technique for resource acquisition is to first read the bookkeeping information to obtain a local copy, modify that local copy to indicate that one or more resources are acquired, and then to perform an atomic operation to store the modified bookkeeping information to its original location. This atomic operation checks whether the value in the original location has not changed from the time that the thread read that value. If it has changed, then the atomic operation fails and the entire operation to acquire resources is repeated. The value may change because a different thread of execution may be working on the same bookkeeping information at the same time and may have thus acquired the resource before the first thread was able to. This type of contention is inefficient.

To counteract this type of contention, a hardware-accelerated instruction for acquiring resources is provided herein. This instruction specifies the address of bookkeeping information as well as information indicating desired resources. When executed, the instruction atomically reads the bookkeeping information at the address to obtain a local copy, modifies that local copy to acquire the requested resources, and writes the modified local copy back to the address. These operations prevent the need to repeatedly attempt to acquire the resources due to the atomic operation failing as described above. More specifically, this hardware-accelerated instruction can be seen as a custom read-modify-write operation that reads the bookkeeping information, modifies it as requested by the instruction, and writes that instruction back to memory. Where previously only the final attempt to write the changed results was atomic, in the hardware-accelerated instruction, the atomic nature of the instruction spans the original read of the bookkeeping information, modification of that information, and the write-back of the modified information to memory. This hardware-accelerated instruction thus improves performance by eliminating the type of failure in resource acquisition mentioned above.

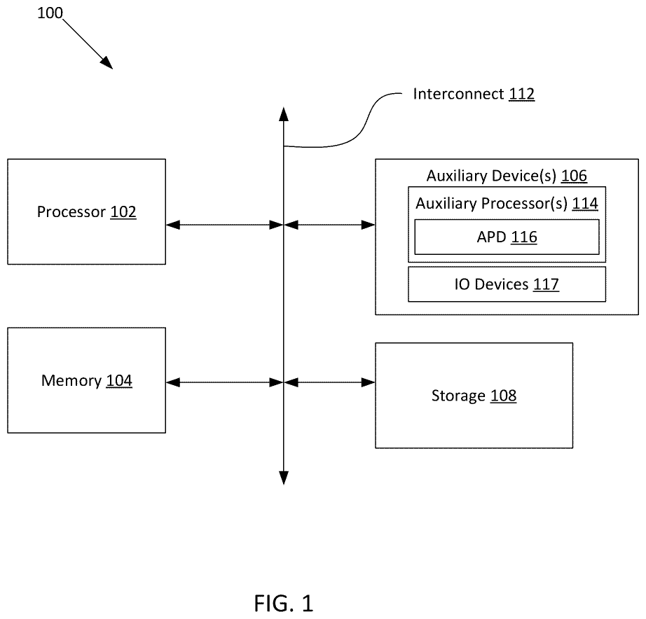

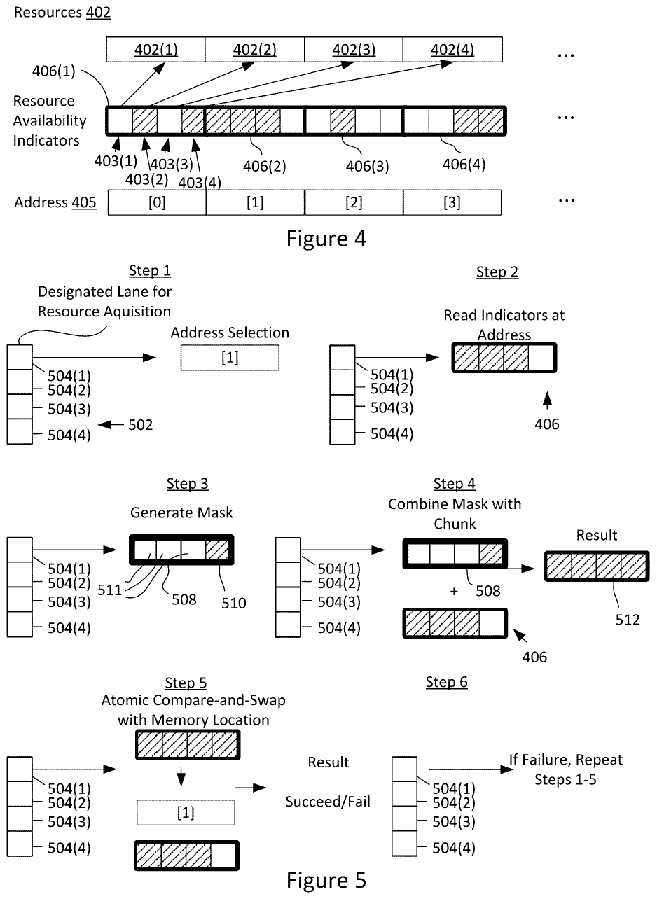

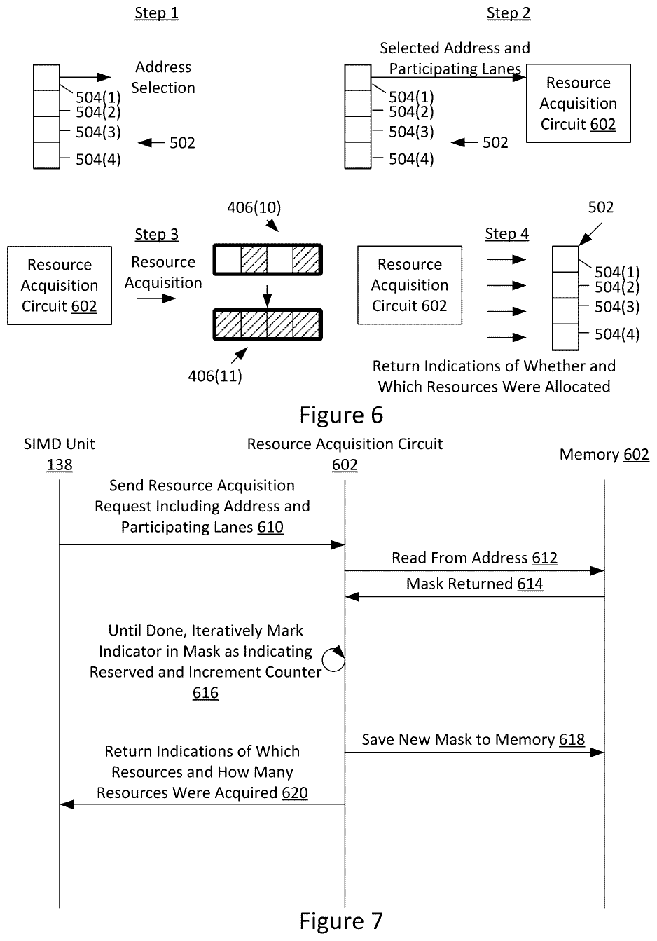

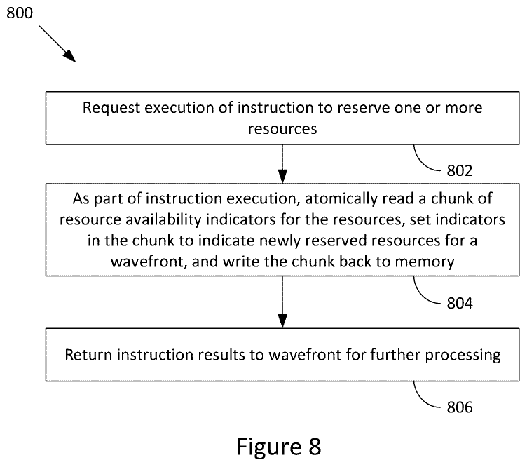

Herein, FIGS. 1-3 illustrate example hardware in which the techniques described herein can be implemented. FIG. 4 illustrates bookkeeping information (“resource availability indicators”) and corresponding resources 402. FIG. 5 illustrates one technique for acquiring resources. FIG. 6 illustrates a different technique for acquiring resources, using a hardware-accelerated instruction. FIG. 7 illustrates details of the hardware-accelerated instruction. FIG. 8 is a flow diagram of a method for acquiring resources.

FIG. 1 is a block diagram of an example computing device 100 in which one or more features of the disclosure can be implemented. In various examples, the computing device 100 is one of, but is not limited to, for example, a computer, a gaming device, a handheld device, a set-top box, a television, a mobile phone, a tablet computer, or other computing device. The device 100 includes, without limitation, one or more processors 102, a memory 104, one or more auxiliary devices 106, and a storage 108. An interconnect 112, which can be a bus, a combination of buses, and/or any other communication component, communicatively links the one or more processors 102, the memory 104, the one or more auxiliary devices 106, and the storage 108.

In various alternatives, the one or more processors 102 include a central processing unit (CPU), a graphics processing unit (GPU), a CPU and GPU located on the same die, or one or more processor cores, wherein each processor core can be a CPU, a GPU, or a neural processor. In various alternatives, at least part of the memory 104 is located on the same die as one or more of the one or more processors 102, such as on the same chip or in an interposer arrangement, and/or at least part of the memory 104 is located separately from the one or more processors 102. The memory 104 includes a volatile or non-volatile memory, for example, random access memory (RAM), dynamic RAM, or a cache.

The storage 108 includes a fixed or removable storage, for example, without limitation, a hard disk drive, a solid state drive, an optical disk, or a flash drive. The one or more auxiliary devices 106 include, without limitation, one or more auxiliary processors 114, and/or one or more input/output (“IO”) devices. The auxiliary processors 114 include, without limitation, a processing unit capable of executing instructions, such as a central processing unit, graphics processing unit, parallel processing unit capable of performing compute shader operations in a single-instruction-multiple-data form, multimedia accelerators such as video encoding or decoding accelerators, or any other processor. Any auxiliary processor 114 is implementable as a programmable processor that executes instructions, a fixed function processor that processes data according to fixed hardware circuitry, a combination thereof, or any other type of processor.

The one or more auxiliary devices 106 includes an accelerated processing device (“APD”) 116. The APD 116 may be coupled to a display device, which, in some examples, is a physical display device or a simulated device that uses a remote display protocol to show output. The APD 116 is configured to accept compute commands and/or graphics rendering commands from processor 102, to process those compute and graphics rendering commands, and, in some implementations, to provide pixel output to a display device for display. As described in further detail below, the APD 116 includes one or more parallel processing units configured to perform computations in accordance with, for example, a single-instruction-multiple-data (“SIMD”) or a single-instruction-multiple-thread (“SIMT”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and, optionally, configured to provide graphical output to a display device. For example, it is contemplated that any processing system that performs processing tasks in accordance with a SIMD paradigm may be configured to perform the functionality described herein. Alternatively, it is contemplated that computing systems that do not perform processing tasks in accordance with a SIMD paradigm perform the functionality described herein.

The one or more IO devices 117 include one or more input devices, such as a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals), and/or one or more output devices such as a display device, a speaker, a printer, a haptic feedback device, one or more lights, an antenna, or a network connection (e.g., a wireless local area network card for transmission and/or reception of wireless IEEE 802 signals).

As described in further detail below, the APD 116 includes one or more parallel processing units to perform computations in accordance with a single-instruction-multiple-data (“SIMD”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and provides graphical output to a display device 118. For example, it is contemplated that any processing system that performs processing tasks in accordance with a SIMD paradigm may perform the functionality described herein. Alternatively, it is contemplated that computing systems that do not perform processing tasks in accordance with a SIMD paradigm performs the functionality described herein.

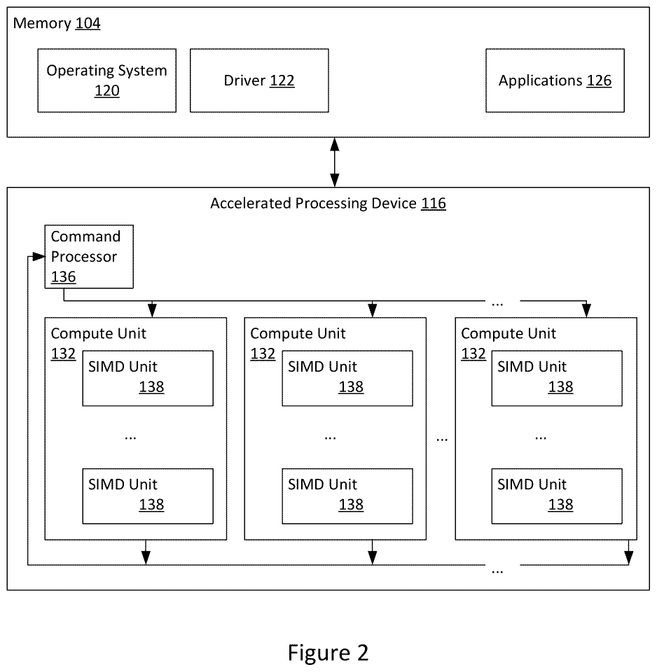

FIG. 2 is a block diagram of the device 100, illustrating additional details related to execution of processing tasks on the APD 116, according to an example. The processor 102 maintains, in system memory 104, one or more control logic modules for execution by the processor 102. The control logic modules include an operating system 120, a driver 122, and applications 126. These control logic modules control various features of the operation of the processor 102 and the APD 116. For example, the operating system 120 directly communicates with hardware and provides an interface to the hardware for other software executing on the processor 102. The driver 122 controls operation of the APD 116 by, for example, providing an application programming interface (“API”) to software (e.g., applications 126) executing on the processor 102 to access various functionality of the APD 116. In some examples, the driver 122 also includes a just-in-time compiler that compiles programs for execution by processing components (such as the SIMD units 138 discussed in further detail below) of the APD 116.

The APD 116 executes commands and programs for selected functions, such as graphics operations and non-graphics operations that may be suited for parallel processing. The APD 116 can be used for executing graphics pipeline operations such as pixel operations, geometric computations, and rendering an image based on commands received from the processor 102. The APD 116 also executes compute processing operations that are not directly related to graphics operations, such as operations related to video, physics simulations, computational fluid dynamics, neural computing, artificial intelligence (AI) tasks, or other tasks, based on commands received from the processor 102. In some examples, the APD 116 does not perform graphics operations.

In this example, the APD 116 includes compute units 132 that include one or more SIMD units 138 that perform operations at the request of the processor 102 in a parallel manner according to a SIMD paradigm. The compute units 132 are sometimes referred to as “parallel processing units” herein. Each compute unit 132 includes a local data share (“LDS”) 137 that is accessible to wavefronts executing in the compute unit 132 but not to wavefronts executing in other compute units 132. A global memory 139 stores data that is accessible to wavefronts executing on all compute units 132. In some examples, the local data share 137 has faster access characteristics than the global memory 139 (e.g., lower latency and/or higher bandwidth). Although shown in the APD 116, the global memory 139 can be partially or fully located in other elements, such as in system memory 104 or in another memory not shown or described. The SIMD paradigm is one in which multiple processing elements share a single program control flow unit and program counter and thus execute the same program but are able to execute that program with different data. In one example, each SIMD unit 138 includes sixteen lanes, where each lane executes the same instruction at the same time as the other lanes in the SIMD unit 138 but can execute that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow.

The basic unit of execution in compute units 132 is a work-item. Each work-item represents a single instantiation of a program that is to be executed in parallel in a particular lane. Work-items can be executed simultaneously as a “wavefront” on a single SIMD processing unit 138. One or more wavefronts are included in a “work group,” which includes a collection of work-items designated to execute the same program. A work group can be executed by executing each of the wavefronts that make up the work group. In alternatives, the wavefronts are executed sequentially on a single SIMD unit 138 or partially or fully in parallel on different SIMD units 138. Wavefronts can be thought of as the largest collection of work-items that can be executed simultaneously on a single SIMD unit 138. Thus, if commands received from the processor 102 indicate that a particular program is to be parallelized to such a degree that the program cannot execute on a single SIMD unit 138 simultaneously, then that program is broken up into wavefronts which are parallelized on two or more SIMD units 138 or serialized on the same SIMD unit 138 (or both parallelized and serialized as needed). A scheduler 136 performs operations related to scheduling various wavefronts on different compute units 132 and SIMD units 138.

The parallelism afforded by the compute units 132 is suitable for graphics related operations such as pixel value calculations, vertex transformations, and other graphics operations as well as various compute or AI operations. Thus in some instances, a graphics pipeline, which accepts graphics processing commands from the processor 102, provides computation tasks to the compute units 132 for execution in parallel.

The compute units 132 are also used to perform computation tasks not related to graphics or not performed as part of the “normal” operation of a graphics pipeline (e.g., custom operations performed to supplement processing performed for operation of the graphics pipeline). An application 126 or other software executing on the processor 102 transmits programs that define such computation tasks to the APD 116 for execution.

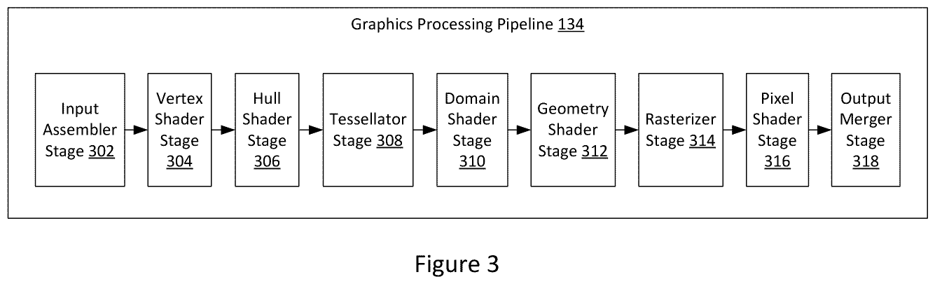

FIG. 3 is a block diagram showing additional details of the graphics processing pipeline 134 illustrated in FIG. 2. The graphics processing pipeline 134 includes stages that each performs specific functionality of the graphics processing pipeline 134. Each stage is implemented partially or fully as shader programs executing in the programmable compute units 132, or partially or fully as fixed-function, non-programmable hardware external to the compute units 132.

The input assembler stage 302 reads primitive data from user-filled buffers (e.g., buffers filled at the request of software executed by the processor 102, such as an application 126) and assembles the data into primitives for use by the remainder of the pipeline. The input assembler stage 302 can generate different types of primitives based on the primitive data included in the user-filled buffers. The input assembler stage 302 formats the assembled primitives for use by the rest of the pipeline.

The vertex shader stage 304 processes vertices of the primitives assembled by the input assembler stage 302. The vertex shader stage 304 performs various per-vertex operations such as transformations, skinning, morphing, and per-vertex lighting. Transformation operations include various operations to transform the coordinates of the vertices. These operations include one or more of modeling transformations, viewing transformations, projection transformations, perspective division, and viewport transformations, which modify vertex coordinates, and other operations that modify non-coordinate attributes.

The vertex shader stage 304 is implemented partially or fully as vertex shader programs to be executed on one or more compute units 132. The vertex shader programs are provided by the processor 102 and are based on programs that are pre-written by a computer programmer. The driver 122 compiles such computer programs to generate the vertex shader programs having a format suitable for execution within the compute units 132.

The hull shader stage 306, tessellator stage 308, and domain shader stage 310 work together to implement tessellation, which converts simple primitives into more complex primitives by subdividing the primitives. The hull shader stage 306 generates a patch for the tessellation based on an input primitive. The tessellator stage 308 generates a set of samples for the patch. The domain shader stage 310 calculates vertex positions for the vertices corresponding to the samples for the patch. The hull shader stage 306 and domain shader stage 310 can be implemented as shader programs to be executed on the compute units 132, that are compiled by the driver 122 as with the vertex shader stage 304.

The geometry shader stage 312 performs vertex operations on a primitive-by-primitive basis. A variety of different types of operations can be performed by the geometry shader stage 312, including operations such as point sprite expansion, dynamic particle system operations, fur-fin generation, shadow volume generation, single pass render-to-cubemap, per-primitive material swapping, and per-primitive material setup. In some instances, a geometry shader program that is compiled by the driver 122 and that executes on the compute units 132 performs operations for the geometry shader stage 312.

The rasterizer stage 314 accepts and rasterizes simple primitives (triangles) generated upstream from the rasterizer stage 314. Rasterization consists of determining which screen pixels (or sub-pixel samples) are covered by a particular primitive. Rasterization is performed by fixed function hardware.

The pixel shader stage 316 calculates output values for screen pixels based on the primitives generated upstream and the results of rasterization. The pixel shader stage 316 may apply textures from texture memory. Operations for the pixel shader stage 316 are performed by a pixel shader program that is compiled by the driver 122 and that executes on the compute units 132.

The output merger stage 318 accepts output from the pixel shader stage 316 and merges those outputs into a frame buffer, performing operations such as z-testing and alpha blending to determine the final color for the screen pixels.

It is a common paradigm in computing to manage resource allocation using bookkeeping information that indicates whether each such resource is allocated or free. In one example, a memory allocation algorithm tracks the allocation status of blocks of memory (e.g., contiguous portions of memory). According to such an algorithm, a large section of memory is divided into blocks. For each block, an indicator is stored that indicates whether that block has been allocated to program operations (e.g., via a “malloc” operation in C, which allocates memory and assigns the address of the allocated memory to a pointer variable). In order to allocate new memory, the allocation algorithm must examine the bookkeeping information to learn which blocks are free, determine which free blocks to allocate, and then to alter the bookkeeping information to indicate that the newly allocated blocks are actually allocated. In another example, a queue (e.g., a work-queue) includes a plurality of slots, where each slot includes a task to be performed. A separate set of bookkeeping information indicates which slots include valid tasks. A slot that does not include a valid task is considered free and thus a new task can be placed into that slot. The bookkeeping information is thus used to determine which slots to place tasks into. The bookkeeping information described above is sometimes referred to as “resource availability indicators” herein.

FIG. 4 illustrates resources tracked by resource availability indicators, according to an example. The resources 402 are any technically feasible resources, such as blocks of memory that are either free or allocated, slots in a work queue that either contain valid work or invalid work (and are thus available for allocation), or any other resource that can be considered either available or not available. The resource availability indicators 403 indicate which resources 402 are available. More specifically, each resource availability indicator 403 is associated with a specific resource 402 and indicates whether that resource is available. In the Figures, a shaded box for a resource availability indicator 403 indicates that the resource is not available and a solid white box indicates that the resource 402 is available. Also, in FIG. 4, resource availability indicator 403(1) indicates whether resource 402(1) is available, resource availability indicator 403(2) indicates whether resource 402(2) is available, resource availability indicator 403(3) indicates whether resource 402(3) is available, and resource availability indicator 403(4) indicates whether resource 402(4) is available.

In some examples, the resource availability indicators 403 are stored in chunks 406 where each chunk 406 has an address 405 in the memory space. In other words, the resource availability indicators 403 are stored in memory and each chunk 406 has an address in that memory. In some examples, each resource availability indicator 403 is a bit in a bitmask, and each address points to a chunk of multiple bits (e.g., a byte).

It is possible to perform resource allocation and tracking for a single-instruction-multiple-data (“SIMD”) execution unit of a processor. As described elsewhere herein, SIMD execution is a mode of execution in which a processing unit executes the same program simultaneously for multiple “lanes” of execution, though lanes can have divergent execution, in which case serialization of the different control flow paths occurs. Herein, each parallel unit of execution is a “work-item” and the collection of work-items that execute in lockstep in a SIMD manner is a “wavefront.” In an example, each work-item separately is to acquire one or more resources. It is important in this scenario to efficiently obtain resources using the resource availability indicators 403, as many work-items executing in lockstep, each accessing the same set of resource availability indicators 403, could result in a very high amount of traffic to memory. Moreover, for correctness of execution, accesses to the resource availability indicators is performed atomically, and many atomic accesses to the same data elements can result in a very high performance cost.

FIG. 5 illustrates a set of operations for acquiring resources by a wavefront 502, according to an example. In this example, a set of 6 steps is shown. Steps are performed in numerical order (e.g., step 1, then step 2, and so on). In each step, a single work-item 504(1) of a wavefront 502 has been designated to obtain resources for all of the work-items 504 of the wavefront 502. Using one work-item 504 in this manner reduces the amount of memory contention within a wavefront 502 that would occur if each lane were individually attempting to acquire its own resource, since the multiple resource availability indicators 403 at each address are read together (e.g., an entire byte is read, which brings in multiple bits).

In step 1, the work-item 504(1) is the designated lane for resource acquisition. In various examples, this designation can be performed by selecting any (e.g., the lowest-numbered, where wavefronts contain a plurality of work-items each having a numerical identifier) work-item 504 that is currently active (e.g., not switched off) and by switching all other lanes of the wavefront 502 off during resource acquisition.

In addition, in step 1, the work-item 504(1) selects an address to obtain a chunk 406 of resource availability indicators 403. The address selection can be made in any technically feasible manner. In an example, the work-item 504 maintains information indicating which address is the next address to select. When an address is selected and the indicators 403 at that address are processed, the work-item 504 proceeds to the next address. The addresses can start at a base address of the resource availability indicators 403 and extend to a largest offset from that base address.

At step 2, the work-item 504(1) reads the indicators 403 at the address. As can be seen, at step 2, a chunk 406 of indicators 403 has been read from address [1].

At step 3, the work-item 504(1) generates a mask based on the indicators read at the selected address. The mask is a mask of indicators 403 in the chunk 406 that are free. In some examples, the mask also takes into account which work-items 504 of the wavefront 502 are participating in the resource acquisition. For example, if there are more lanes that are participating in the resource acquisition than there are resource availability indicators 403 in the chunk 406, then the mask would indicate a number of free indicators 403 that is equal to the number of participating work-items 504 (which is less than the number of free indicators in the chunk 406 that was read). In the example of FIG. 5, the mask 508 that is generated includes one free indicator 510 and three 511 unfree indicators. The free indicator 510 is in the position within the mask 508 of the indicator 403 that a resource is not already allocated and is thus available (the final position in chunk 406 in step 2).

At step 4, the work-item 504(1) combines the mask 508 with the chunk 406 at the selected address to produce a result 512. The result is the updated value for the chunk 406 to be stored at the selected address. This updated value includes an indication that a resource is acquired and thus not available for all of the resources already indicated as unavailable at step 2, as well as the resource newly acquired at step 3. In other words, the update to the chunk 406 sets the resource availability indicators 403 for the resources allocated in step 3 to indicate that those resources are allocated. The combining with the original mask 508 includes the resources already allocated in the updated value for the chunk 406.

At step 5, the work-item 504(1) performs an atomic compare-and-swap operation to set the value of the chunk 406 at the address selected at step 1 to be the result 512 of step 4. In other words, step 5 updates the resource availability indicators 403 in memory to store the result 512 obtained in step 4. This update is performed atomically because it is possible for other wavefronts to be working on indicators of the same address at any given point in time. More specifically, multiple wavefronts execute in parallel. Moreover, any of these wavefronts can be attempting to obtain resources in parallel in this way, and there is no guarantee that two or more such wavefronts will not be attempting to acquire resources represented by the exact same chunk 406 of resource availability indicators 403. Thus, at step 5, the work-item 504(1) performs an atomic compare and swap that atomically compares the value at the selected address with the value previously read from that address at step 2, and updates the value at that address to the result 512 if the comparison is equal. In other words, if the value of the chunk 406 has not changed, then it is determined that no other wavefront has allocated a resource represented by that chunk 406 and thus the allocation operation represented by steps 1-5 have succeeded and the chunk 406 is updated to reflect that operation. However, if the value of the chunk 406 has changed, then the atomic compare and swap operation does not update the value of the chunk 406 in memory. In this situation, at step 6, the work-item repeats steps 1-5, as the allocation failed and must be repeated. The entire set of operations of steps 1-6 are also repeated in the event that the work-item 504(1) needs to allocate additional resources, such as if there were no free resources in the chunk 406 or if the number of resources allocated in steps 5 was less than the number of resources needed for the wavefront 502 (e.g., if there were more work-items needing resources than there were free indicators 403 in the chunk 406).

One downside of the technique described above is that, with many wavefronts potentially performing these operations simultaneously on the same resource availability indicators 403, there is a lot of traffic to memory, and much of that traffic represents wasted effort. More specifically, if a number of different wavefronts 502 are attempting to acquire resources represented by the same chunk 406, each such wavefront 502 is reading the same chunk 406 from memory, but only one such wavefront 502 is able to acquire a resource, with the remaining wavefront needing to continue attempting to acquire resources until completion. For at least these reasons, a different technique is provided in which much of the resource acquisition operations that are performed by a set of several different instructions executed by a work-item of a wavefront 502 are condensed down into a single instruction whose operations are performed more efficiently in hardware (e.g., by digital circuitry).

FIG. 6 illustrates a set of operations utilizing the resource acquisition instruction, according to an example. At step 1, the work-item 504(1) of a wavefront 502 selects an address within the resource availability indicators 403 for resource acquisition. This selection is performed in a similar manner as with step 1 in FIG. 1. In an example, this selection chooses the address indicated in a variable that indicates the “next available chunk 406,” as tracked by the wavefront 502. The wavefront 502 updates this variable as the wavefront 502 proceeds through the chunks 406 of the resource availability indicators 403. The steps illustrated in FIG. 6 can be repeated as many times as necessary to acquire a desired amount of resources.

At step 2, the work-item 504(1) requests that a resource acquisition circuit 602 acquire resources for the wavefront 502. The resource acquisition circuit 602 is a circuit (e.g., a digital circuit) within a processor (e.g., processor 102 or APD 116) that performs operations described herein for allocating resources by manipulating chunks 406 of resource availability indicators 403. In some examples, this resource acquisition circuit 602 is dedicated circuitry that performs operations for a resource acquisition instruction. This resource acquisition instruction is an instruction in the instruction set architecture of the processor. Thus, the resource acquisition circuit 602 provides hardware acceleration for the functionality of resource acquisition. In some examples, the work-item 504(1) triggers the operation of the resource acquisition circuit 602 by executing an instruction to acquire resources. This instruction provides the address of the chunk 406 as well as an indication of which work-items 504 of the wavefront 502 are participating in the operation to acquire resources. Then, at step 3, the resource acquisition circuit 602 performs the requested operations to allocate the resources. In particular, the resource acquisition circuit 602 searches the chunk 406 at the specified address for indicators indicating that resources are free, and sets one or more such indicators to indicate that the resources are no longer available. The number of resource availability indicators set in this manner is less than or equal to the number of participating lanes specified in step 2. In particular, if the number of participating lanes is less than or equal to the number of free indicators in the chunk 406 before step 3, then there are at least enough resources in the chunk 406 to allocate to all participating lanes, and that number is reserved in the chunk 406. If the number of participating lanes is greater than the number of free indicators, then the number of reserved resources is less than the number of participating lanes.

At step 4, after completing the reservation operations for the chunk 406, the resource acquisition circuit 602 returns the results of these operations to the wavefront 502 that requested execution of the instruction. The results include the number of resources that were allocated (e.g., the number of slots set from “free” to “reserved”), and also includes an indication of which work-item(s) 504 had their resources allocated. In some examples, the indication of which work-item(s) 504 had their resources allocated is embodied as a vector value returned into a vector register of the wavefront. A vector register is a register (low latency scratch space usable by work-items 504 of the wavefront 502) with multiple slots, where each slot corresponds to a different work-item 504. Placing an indicator into each slot thus allows each lane to access its corresponding indicator. In other words, for each lane, the resource acquisition circuit 602 places an indicator of whether a resource was allocated for that lane and, if so, which slot in the chunk 406 the allocation occurred for. For instance, if the resource acquisition circuit 602 allocated changed the value of a first indicator 403 in a chunk 406 from “free” to “allocated,” for a first lane 504, then the resource acquisition circuit 602 would place an indication in the vector register slot for the first lane, where that indication indicates that the resource for the first indicator 403 was allocated to the first lane. In the instance that no resource was able to be allocated for a lane (e.g., because there were too few free indicators 403 in the specified chunk 406), then the resource acquisition circuit 602 would place an indicator that no resource was allocated for the lane into the slot in the vector register corresponding to that lane.

In summary, according to the technique of FIG. 6, a wavefront 502 reserves resources for its lanes by executing an instruction to do so. A single work-item 504 of the wavefront 502 executes this instruction, and provides an indication of the address of a chunk 406 of free indicators 403 as well as an indication of which lanes of the wavefront 502 are requesting resource allocation. The instruction triggers a resource acquisition circuit 602 to perform operations to acquire the resources at the chunk 406. Specifically, the resource acquisition circuit 602 examines the chunk 406 to find resource availability indicators 403 indicating that a resource is free. For each participating lane, the resource acquisition circuit 602 sets the free indicator 403 in the chunk to indicate that the resource is acquired and returns an indication of that resource to the participating lane. If a resource cannot be acquired for a lane (e.g., because there are not enough free resources in the chunk 406), then the resource acquisition circuit 602 returns an indication to that lane that a resource was not acquired. In various examples, if not all lanes of the wavefront 502 that need a resource have acquired the resource, the wavefront 502 executes the instruction again, for a different chunk 406 (or even for the same chunk at a later time).

In general, the resource acquisition circuit 602 acquires the resources for the lanes from the specified chunk 406 by atomically performing the following operations: searching through the chunk for a free indicator 403 indicating that a resource is not yet acquired, setting that indicator 403 to indicate that the resource is acquired, recording the count of acquired resources and which resources (e.g., which slot(s) in the chunk 406) were acquired, and returning the results (the count and indications of which resources were allocated for which lanes) to the wavefront 502. The advantage of performing this set of operations atomically in hardware is that the “failure” loop of step 6 in FIG. 5 is eliminated. In other words, because the resource acquisition circuit 602 performs the operations to acquire resources in a single atomic operation, and this single atomic operation comprises reading the chunk 406 and setting its bits as specified by the instruction from the wavefront 502 (e.g., setting bits for the participating lanes specified by the instruction), there is no opportunity for the value of the chunk 406 in memory to change between reading that value and modifying that value. Thus there is no need to perform the failure loop of step 6. Note that it is possible for the instruction to fail in a different way, such as by not finding any free resources (e.g., no free indicators 403 in the chunk 406 indicate that a resource has not yet been allocated) in the chunk 406. However, not having to perform the failure loop of step 6 of FIG. 5 represents a performance benefit. Note that it is not necessary for all operations described above to be performed atomically. The operations that should be performed as a single atomic operation include reading the chunk 406 and modifying the chunk 406 to indicate that all lanes for which a resource is requested and for which a resource is available in the chunk now have acquired a resource. Thus, the single atomic operation comprises a single read-modify-write operation that reads the chunk 406 and sets the free indicators 403 in the chunk as described above. Note that a description that these operations are performed as a “single atomic operation” means that any access to the chunk 406 by any entity other than the wavefront 502 performing the atomic operation is not permitted, or according to a more relaxed definition, that it appears to software that no such access is permitted (this relaxed definition allows for optimizations such as speculative execution which can perform operations as long as their results are “correct” according to the expectations of software). In other words, the processor is permitted to access the memory for other wavefronts 502 during the atomic operation as long as it is not possible for any software (e.g., any wavefront 502) to observe incorrect execution as a result of such access. In an example, observation of incorrect execution would result if a wavefront 502 executes an atomic operation and, during such execution, the memory operated on by the atomic operation changes as a result of the activity of a different wavefront 502. Operations such as tallying up the number of resources that were acquired (if such tally is necessary) or setting values in a register for the wavefront 502 indicating which and how many resources were required do not need to be performed as part of this single atomic operation.

FIG. 7 illustrates operations for reserving resources, according to an example. At step 610, the SIMD unit 138 executing a wavefront 502 executes an instruction which sends a request to acquire resources to the resource acquisition circuit 602. The request specifies an address of a chunk 406 as well as an indication of which lanes of the wavefront 502 are participating in the acquisition of resources.

Step 612 to at least step 620 is performed as a single atomic operation. At step 612, the resource acquisition circuit 602 reads from the address specified by the instruction (step 610). This address stores the chunk 406 of resource availability indicators 403. At step 614, the memory returns the chunk 406 to the resource acquisition circuit 602. At step 616, the resource acquisition circuit 602 iteratively marks an indicator 403 in the chunk 406 as indicating that a resource is reserved and increments an internal counter maintaining the count of allocated resources. In some examples, this operation is performed as follows: the resource acquisition circuit repeatedly performs the following operation: determine whether a lane still needs a resource, and, if so, whether there is still a free indicator 403 in the chunk 406 that indicates that a resource is not yet acquired; if a lane still needs a resource and there is still a free indicator 403 indicating that a resource is not acquired, then marking that free indicator 403 as indicating that the corresponding resource is acquired, incrementing the internal counter counting the number of acquired resources, and storing an association between the free indicator 403 that was just marked as acquired and the lane for which that resource was acquired. This repetition continues until either all lanes for which a resource has been requested have been allocated a resource or until the chunk 406 has no more free indicators 403 indicating that a resource has not yet been acquired. After this operation, in step 618, the resource acquisition circuit 602 saves the updated mask (e.g., the chunk 406 with modifications from step 616) to memory. This is saved to the same address as read from at step 612. Because steps 610-618 are performed as a single atomic operation, there is no opportunity for another wavefront 502 to modify the chunk 406 in memory while the chunk 406 is being operated on by the operations of FIG. 7. At step 620, the resource acquisition circuit 602 returns indications of whether and which resource was allocated for each lane for which acquired was requested, as well as how many resources were acquired. This is returned to the wavefront 502 that executed the instruction.

FIG. 8 is a flow diagram of a method 800 for reserving resources, according to an example. Although described with respect to the system of FIGS. 1-7, those of skill in the art will understand that any system configured to perform the steps of the method 800 in any technically feasible order falls within the scope of the present disclosure.

At step 802, a wavefront 502 requests execution of an instruction to reserve one or more resources. The resources can be any technically feasible resources. Bookkeeping information that includes a set of resource availability indicators 403 are stored in a memory such as system memory 104 or global memory for the APD 116. The free resources indicators 403 are stored in chunks 406, each of which is at a particular address. Each chunk 406 includes a plurality of resource availability indicators 403. Each resource availability indicators 403 indicates whether a corresponding resource 402 is free or already allocated. The resources 402 can be any technically feasible resources. In some examples, each resource 402 is a block of memory that can be allocated in a memory allocation algorithm (e.g., memory allocated with the “malloc” function in the C programming language). In other examples, each resource 402 is a slot of a work queue. Such a work queue has a plurality of slots, each of which can store work to be performed by a processor. Each slot can have either valid work or invalid work (i.e., no work to be performed). Bookkeeping information embodied as the resource availability indicators 403 keep track of which slots have invalid work so that when an entity wishes to queue work for execution, that entity is able to identify a slot that is available to store such work for execution. The instruction that is referred to in step 802 specifies an address of a chunk 406 as well as an indication of which lanes of a wavefront 502 require a resource to be allocated.

At step 804, a resource acquisition circuit 602 executes the instruction. Part of this execution includes performing atomic operations to reserve resources of the chunk 406 for the wavefront 502. These atomic operations include performing, as a single atomic operation, the following: reading the chunk 406 from memory, identifying, in the chunk 406, the resource availability indicators 403 indicating that a corresponding resource has not been acquired, setting each such resource availability indicators 403 to indicate that a resource has been acquired, for each lane of the wavefront 502 that requires a resource, and writing the resulting chunk 406 back to the memory address from which that chunk was read. In some examples, these operations are performed as steps 612 to 618 of FIG. 7.

At step 806, the resource acquisition circuit 602 returns the results of the instruction back to the wavefront 502. The results include an indication for each lane of which resource was acquired for that lane as well as an indication of how many resources were acquired by execution of the instruction.

A wavefront 502 and resource acquisition circuit 602 can repeat the steps of the method 800 any number of times as required. In various examples, a wavefront 502 requires a certain number of resources to be acquired. In the event that a single instruction execution acquires fewer than that number, the wavefront 502 examines the results returned from the resource acquisition circuit 602, learns that the instruction has not yet acquired enough resources, and executes the instruction again. This subsequent execution can specify a different address, in order to try to acquire different resources. In one example, the wavefront 502 proceeds through the addresses in numerical sequence until a sufficient number of resources have been acquired. In other examples, the wavefront 502 selects different addresses in a different manner (i.e., not strictly monotonically increasing).

It should be understood that a wavefront 502 is a logical constructed executed by a processor such as a SIMD processor 138 or the processor 102. Each wavefront has a plurality of work-items, and each work-item executes on a lane of the processor. In some examples, the resource acquisition circuit 602 is part of the instruction execution logic (e.g., the arithmetic logic, or “ALU”) of the processor 102. Thus execution of an instruction by a wavefront 502 is a request for the instruction execution logic to perform the operations for that instruction.

Although described as wavefronts 502 performed on an APD 116, any technically feasible construct that executes in a SIMD manner can perform the operations described herein. In addition, although SIMD operations are described, this term should be understood to encompass other similar technologies, such as “single instruction multiple thread” (“SIMT”), which execute multiple work-items in lockstep, but where each lane can have divergent execution as described elsewhere herein.

The terms “acquiring,” “allocating,” or “reserving” resources, as used herein, should be understood as having the same meaning.

It should be understood that many variations are possible based on the disclosure herein. Although features and elements are described above in particular combinations, each feature or element can be used alone without the other features and elements or in various combinations with or without other features and elements.

Each of the units illustrated in the figures represent hardware circuitry configured to perform the operations described herein, software configured to perform the operations described herein, or a combination of software and hardware configured to perform the steps described herein. For example, the processor 102, memory 104, any of the auxiliary devices 106, the storage 108, the scheduler 136, compute units 132, SIMD units 138, input assembler stage 302, vertex shader stage 304, hull shader stage 306, tessellator stage 308, domain shader stage 310, geometry shader stage 312, rasterizer stage 314, pixel shader stage 316, output merger stage 318, or resource acquisition circuit 602, may be implemented as “hardware,” “software” or any technically feasible combination thereof; where “hardware” includes, without limitation, a general purpose computer, a processor, a processor core, a programmable logic device, a field programmable gate array, a digital circuit, an analog circuit, a fixed-function circuit; and where “software,” includes, without limitation, a program, an app, firmware, an application, a device driver, or any other set of executable instructions, stored in a non-transitory computer readable medium or in another medium, executable by a general purpose computer, a processor, or a processor core, or as any technically feasible combination of hardware or software. The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements aspects of the embodiments.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method for acquiring one or more resources, the method comprising:
triggering execution of an instruction to allocate the one or more resources, the instruction specifying an address of a chunk of resource availability indicators; and
executing the instruction by atomically performing operations including: reading the chunk from memory to obtain a local copy of the chunk, setting indicators in the local copy of the chunk according to the instruction to obtain a modified local copy of the chunk, and writing the modified local copy of the chunk to the address.

2. The method of claim 1, wherein the triggering is performed by a wavefront.

3. The method of claim 2, further comprising returning an indication of how many resources were reserved to the wavefront.

4. The method of claim 2, further comprising returning associations between work-items of the wavefronts and resources allocated for those work-items, to the wavefront.

5. The method of claim 2, wherein the instruction includes an indication of which work-items of the wavefront are requesting allocation of a resource.

6. The method of claim 2, further comprising performing the instruction a second time for a second address by repeating the triggering and the executing to acquire additional resources at the second address.

7. The method of claim 6, wherein the instruction fails to acquire all requested resources a first time and the performing the instruction the second time is performed in response.

8. The method of claim 6, wherein setting the indicators in the local copy of the chunk comprises setting an indicator in the local copy for each lane of the wavefront that requests a resource.

9. The method of claim 6, wherein setting the indicators in the local copy of the chunk comprises setting fewer indicators in the local copy than a number of lanes that request a resource, and returning an indication to the wavefront that at least one lane was unable to acquire a resource.

10. A system for acquiring one or more resources, the system comprising:
a memory; and
a processor configured to:
trigger execution of an instruction to allocate the one or more resources, the instruction specifying an address of a chunk of resource availability indicators; and
executing the instruction by atomically performing operations including: reading the chunk from the memory to obtain a local copy of the chunk, setting indicators in the local copy of the chunk according to the instruction to obtain a modified local copy of the chunk, and writing the modified local copy of the chunk to the address.

11. The system of claim 10, wherein the triggering is performed by a wavefront.

12. The system of claim 11, wherein the processor is further configured to return an indication of how many resources were reserved to the wavefront.

13. The system of claim 11, wherein the processor is further configured to return associations between work-items of the wavefronts and resources allocated for those work-items, to the wavefront.

14. The system of claim 11, wherein the instruction includes an indication of which work-items of the wavefront are requesting allocation of a resource.

15. The system of claim 11, wherein the processor is further configured to perform the instruction a second time for a second address by repeating the triggering and the executing to acquire additional resources at the second address.

16. The system of claim 15, wherein the instruction fails to acquire all requested resources a first time and the performing the instruction the second time is performed in response.

17. The system of claim 15, wherein setting the indicators in the local copy of the chunk comprises setting an indicator in the local copy for each lane of the wavefront that requests a resource.

18. The system of claim 15, wherein setting the indicators in the local copy of the chunk comprises setting fewer indicators in the local copy than a number of lanes that request a resource, and returning an indication to the wavefront that at least one lane was unable to acquire a resource.

19. A non-transitory computer-readable medium storing instructions that, when executed by a processor, cause the processor to perform operations for acquiring one or more resources, the operations comprising:
triggering execution of an instruction to allocate the one or more resources, the instruction specifying an address of a chunk of resource availability indicators; and
executing the instruction by atomically performing operations including: reading the chunk from memory to obtain a local copy of the chunk, setting indicators in the local copy of the chunk according to the instruction to obtain a modified local copy of the chunk, and writing the modified local copy of the chunk to the address.

20. The non-transitory computer-readable medium of claim 19, wherein the triggering is performed by a wavefront.
